(19) United States
(12) Patent Application Publication
(10) Pub. No.: US 2023/0297976 A1
(43) Pub. Date: Sep. 21, 2023

(54) CONTROL METHOD, CONTROL DEVICE, AND RECORDING MEDIUM

(71) Applicant: Panasonic Intellectual Property Corporation of America, Torrance, CA (US)

(72) Inventors: Junji MICHIYAMA, Fukuoka (JP); Yuji UNAGAMI, Osaka (JP); Naohisa NISHIDA, Osaka (JP); Kakuya YAMAMOTO, Hyogo (JP); Junichiro SOEDA, Nara (JP); Yuuki HIROSE, Osaka (JP); Motoji OHMORI, Osaka (JP); Tetsuji FUCHIKAMI, Osaka (JP)

(21) Appl. No.: 18/203,199

(22) Filed: May 30, 2023

Related U.S. Application Data
(63) Continuation of application No. PCT/JP2021/039411, filed on Oct. 26, 2021.
(60) Provisional application No. 63/120,929, filed on Dec. 3, 2020.

(51) Int. Cl. G06Q 20/06; G06Q 20/38; H04L 9/00; H04L 9/32; G06Q 20/40

(52) U.S. Cl. CPC G06Q 20/06; G06Q 20/389; G06Q 20/401; H04L 9/3247; H04L 9/50; G06Q 2220/00; H04L 2209/56

(57) ABSTRACT

A control method that is performed by a first device included in a plurality of devices includes: receiving, from a terminal being used by a second user, first transaction data indicating that value information is to be transferred from a first user to the second user; and storing the received first transaction data into a distributed ledger.

### CROSS REFERENCE TO RELATED APPLICATIONS

This is a continuation application of PCT International Application No. PCT/JP2021/039411 filed on Oct. 26, 2021, designating the United States of America, which is based on and claims priority of U.S. Provisional Pat. Application No. 63/120929 filed on Dec. 3, 2020. The entire disclosures of the above-identified applications, including the specifications, drawings and claims are incorporated herein by reference in their entirety.

### FIELD

The present disclosure relates to control methods, control devices, and recording media.

### BACKGROUND

There is a technique that automatically executes trade transaction procedures using the blockchain technology (refer to Patent Literature (PTL) 1).

### CITATION LIST

### Patent Literature

PTL 1: Japanese Patent No. 6718980

### SUMMARY

### Technical Problem

However, the technique of performing, using a blockchain, a process for addressing a problem that has occurred in a transaction is not known.

In view of this, the present disclosure provides a control method in which a process for addressing a problem that has occurred in a transaction can be easily performed.

### Solution to Problem

A control method according to one aspect of the present disclosure is performed by a first device included in a plurality of devices. The control method includes: receiving, from a terminal being used by a second user, first transaction data indicating that value information is to be transferred from a first user to the second user; and storing, into a distributed ledger, the first transaction data received.

Note that these general and specific aspects may be implemented using a system, a device, an integrated circuit, a computer program, or a computer-readable recording medium such as compact disc read-only memory (CD-ROM), or any combination of systems, devices, integrated circuits, computer programs, or recording media.

### Advantageous Effects

With the control method according to the present disclosure, it is possible to easily perform a process for addressing a problem that has occurred in a transaction.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is an explanatory diagram illustrating the configuration of a management system according to Embodiment 1.

FIG. 2 is a block diagram illustrating the configuration of a server according to Embodiment 1.

FIG. 3 is a first flowchart illustrating processes performed by a management system according to Embodiment 1.

FIG. 4 is a second flowchart illustrating processes performed by a management system according to Embodiment 1.

FIG. 5 is a first flowchart illustrating processes performed by a server according to Embodiment 1.

FIG. 6 is a second flowchart illustrating processes performed by a server according to Embodiment 1.

FIG. 7 is an explanatory diagram illustrating a first example of transaction data according to Embodiment 1.

FIG. 8 is an explanatory diagram illustrating an example of contract information according to Embodiment 1.

FIG. 9 is an explanatory diagram illustrating a second example of transaction data according to Embodiment 1.

FIG. 10 is an explanatory diagram illustrating an example of result information according to Embodiment 1.

FIG. 11 is an explanatory diagram illustrating a third example of transaction data according to Embodiment 1.

FIG. 12 is an explanatory diagram illustrating an example of transfer information according to Embodiment 1.

FIG. 13 is a flowchart illustrating processes performed by a management system according to a variation of Embodiment 1.

FIG. 14 is an explanatory diagram illustrating an example of transaction data according to a variation of Embodiment 1.

FIG. 15 is an explanatory diagram illustrating an example of payment information according to a variation of Embodiment 1.

FIG. 16 is a block diagram illustrating the configuration of a server according to Embodiment 2.

FIG. 17 is a first flowchart illustrating processes performed by a management system according to Embodiment 2.

FIG. 18 is a second flowchart illustrating processes performed by a management system according to Embodiment 2.

FIG. 19 is an explanatory diagram illustrating the data structure of a blockchain.

FIG. 20 is an explanatory diagram illustrating the data structure of transaction data.

### DESCRIPTION OF EMBODIMENTS

### Underlying Knowledge Forming Basis of the Present Disclosure

The inventors of the present application have found that the following problem occurs with transaction-related processes described in the “Background” section.

Generally, in a technique in which transaction-related processes are automatically performed using a distributed ledger technology such as a blockchain, a terminal being used by a purchaser who purchased a product or a service generates transaction data indicating payment for the value thereof and stores the transaction data into a distributed ledger. In other words, a terminal being used by a user who is a source of value information generates transaction data for transferring the value information and stores the transaction data into a distributed ledger.

In a transaction, a problem may occur. Examples of the problem may include poor quality of a product purchased by a purchaser and poor quality of a service purchased by a purchaser.

When a problem occurs in a transaction, a purchaser may intend to request a seller to pay value information to the purchaser him or herself.

However, in a technique in which transaction-related processes are automatically performed using a distributed ledger technology, a technique that enables a terminal being used by a purchaser to generate transaction data for payment of value information from a seller to the purchaser and store the transaction data into a distributed ledger is not known. In other words, a technique is not known in which a terminal being used by a user who is a destination of value information generates transaction data for transferring the value information and stores the transaction data into a distributed ledger.

As just described, the technique of performing, using a distributed ledger, a process for addressing a problem that has occurred in a transaction is not known.

Realization of the above-described requesting in the field of distributed ledger technology is advantageous in that processes for more flexible procedures can be performed using a distributed ledger.

Thus, the present disclosure provides a control method in which a process for addressing a problem that has occurred in a transaction can be easily performed.

In order to solve the aforementioned problem, a control method according to one aspect of the present disclosure is performed by a first device included in a plurality of devices. The control method includes: receiving, from a terminal being used by a second user, first transaction data indicating that value information is to be transferred from a first user to the second user; and storing, into a distributed ledger, the first transaction data received.

According to this aspect, a device included in the distributed ledger system can transfer the value information from the first user to the second user by storing, into the distributed ledger, the first transaction data received from a terminal being used by the second user who is a destination of the value information. It has been the case that transaction data received from a terminal being used by a user who is a source of value information is used to transfer the value information; in contrast, said device uses the transaction data received from the terminal being used by a user who is a destination of the value information. This allows a purchaser to request a seller to pay the value information to the purchaser him or herself when a problem occurs in a transaction. In this manner, the distributed ledger system can easily perform a process for addressing a problem that has occurred in a transaction.

For example, the first transaction data may be transaction data indicating that value information owned by the first user is to be reduced and the second user is to receive a same amount of value information as an amount of the value information reduced.

According to this aspect, by using the first transaction data received from the terminal being used by the second user, the device included in the distributed ledger system can more easily transfer the value information from the first user to the second user. In this manner, the distributed ledger system can more easily perform a process for addressing a problem that has occurred in a transaction.

For example, the control method may further include: storing, into the distributed ledger in advance, second transaction data to which a digital signature of the first user and a digital signature of the second user have been added, the second transaction data indicating a condition under which the value information is to be transferred from the first user to the second user; when the first transaction data is received, determining whether the condition indicated in the second transaction data is satisfied; and when the first transaction data is received and it is determined that the condition is satisfied, storing, into the distributed ledger, the first transaction data received.

According to this aspect, the device included in the distributed ledger system manages, using the distributed ledger, the condition under which the value information is to be transferred, and transfers the value information from the first user to the second user using said condition. The condition under which the value information is to be transferred is properly managed in a practically tamper-free manner using the distributed ledger, which makes the transfer of the value information using said condition also proper. Thus, the distributed ledger system can more properly perform a process for addressing a problem that has occurred in a transaction.

For example, the control method may further include: receiving, from the terminal being used by the second user, third transaction data including result information related to a product or a service provided by the first user; and storing, into the distributed ledger, the third transaction data received. The condition indicated in the second transaction data may include a condition that an appropriateness condition to be satisfied by the result information when the product or the service provided by the first user is appropriate is not satisfied.

According to this aspect, the device included in the distributed ledger system manages, using the distributed ledger, the result information received from the terminal being used by the second user, and when the appropriateness condition related to said result information is not satisfied, transfers the value information from the first user to the second user. The result information is properly managed in a practically tamper-free manner using the distributed ledger, which makes the transfer of the value information using said result information also proper. Thus, using the appropriateness condition, the distributed ledger system can more properly perform a process for addressing a problem that has occurred in a transaction.

For example, the result information may be a sensor value obtained by performing sensing on the product provided by the first user or an object obtained through the service provided by the first user.

According to this aspect, using the sensor value as the result information, the device included in the distributed ledger system determines whether the appropriateness condition is satisfied, and when the appropriateness condition is not satisfied, transfers the value information from the first user to the second user. Thus, the distributed ledger system can more easily perform a process for addressing a problem that has occurred in a transaction.

For example, the control method may further include: determining whether third transaction data including result information related to a product or a service provided by the first user has been received from the terminal being used by the second user; and when it is determined that the third transaction data has not been received, transmitting request information for requesting a third-party organization to verify the result information.

According to this aspect, when failing to receive the result information from the terminal being used by the second user, the device included in the distributed ledger system requests, by transmitting the request information, a third-party organization to verify the result information. The third-party organization is expected to verify the result information in response to this request and thus can contribute to said device receiving the result information. In this manner, the distributed ledger system can more properly perform a process for addressing a problem that has occurred in a transaction.

For example, the control method may further include: performing a process of adding a digital signature of the first user to the first transaction data received; after performing the process, verifying the digital signature of the first user added to the first transaction data; and when the digital signature of the first user is successfully verified, storing, into the distributed ledger, the first transaction data received.

According to this aspect, the device included in the distributed ledger system stores, into the distributed ledger, the first transaction data to which the signature of the first user has been added. Since it is expected that the signature of the first user is added on the basis of the acceptance of the content of the first transaction data by the first user, it is possible to properly manage the fact that the first user has accepted the content of the first transaction data. Thus, the distributed ledger system can have the first user acknowledge that a problem has occurred in a transaction, and then easily perform a process for addressing the problem.

For example, when the digital signature of the first user is not added to the first transaction data within a predetermined time after the process is performed, the first transaction data received may be kept from being stored into the distributed ledger.

According to this aspect, the device included in the distributed ledger system does not store, into the distributed ledger, the first transaction data to which the signature of the first user has not been added, and thus it is possible to properly store, into the distributed ledger, a problem the occurrence of which has been acknowledged by the first user. Thus, with regard to a problem the occurrence of which has been acknowledged by the first user, said device can properly and easily perform a process for addressing the problem.

For example, when the digital signature of the first user is not added to the first transaction data within a predetermined time after the process is performed, the first user may be registered on a predetermined list.

According to this aspect, the device included in the distributed ledger system registers, on the list, the first user who does not add the signature to the first transaction data, and therefore can contribute to making a user who is attempting to make a deal with the first user in the future reluctant to make the deal and end up stopping the purchase. Thus, the distributed ledger system can reduce new transactions that may cause a problem while easily performing a process for addressing a problem that has occurred in a transaction.

For example, fourth transaction data may be stored in the distributed ledger, the fourth transaction data including a contract code of a smart contract for performing a transfer process in which the value information is transferred from the first user to the second user, the first transaction data may include a command for executing the smart contract, and the value information may be transferred from the first user to the second user by storing, into the distributed ledger, the first transaction data received and executing the smart contract.

According to this aspect, the device included in the distributed ledger system performs, by executing the smart contract, the transfer process in which the value information is transferred from the first user to the second user. This allows said device to perform a series of processes included in the transfer process as triggered by the transmission of the first transaction data. Thus, the distributed ledger system can more easily perform a process for addressing a problem that has occurred in a transaction.

For example, the transfer process may include: a determination process of determining whether result information related to a product or a service provided by the first user satisfies an appropriateness condition that is to be satisfied by the result information when the product or the service provided by the first user is appropriate; and a storage process of storing, into the distributed ledger, the first transaction data received, when it is determined in the determination process that the result information fails to satisfy the appropriateness condition.

According to this aspect, using the smart contract, the device included in the distributed ledger system can perform the determination process and the storage process as the transfer process. Thus, the distributed ledger system can more easily perform a process for addressing a problem that has occurred in a transaction.

For example, the transfer process may include a requesting process of requesting a third-party organization to verify the result information when it is determined in the determination process that the result information fails to satisfy the appropriateness condition.

According to this aspect, using the smart contract, the device included in the distributed ledger system can perform a notification process included the transfer process. Thus, the distributed ledger system can more properly perform a process for addressing a problem that has occurred in a transaction.

In order to solve the aforementioned problem, a control device according to one aspect of the present disclosure is a first device included in a plurality of devices. The control device includes: a processor; and memory connected to the processor. Using the memory, the processor: receives, from a terminal being used by a second user, first transaction data indicating that value information is to be transferred from a first user to the second user; and stores, into a distributed ledger, the first transaction data received.

This aspect leads to advantageous effects that are substantially the same as those produced by the above-described control method.

In order to solve the aforementioned problem, a recording medium according to one aspect of the present disclosure is a non-transitory, computer-readable recording medium having recorded thereon a program for causing a computer to execute the above-described control method.

This aspect leads to advantageous effects that are substantially the same as those produced by the above-described control method.

Note that these general and specific aspects may be implemented using a system, a device, an integrated circuit, a computer program, or a computer-readable recording medium such as CD-ROM, or any combination of systems, devices, integrated circuits, computer programs, or recording media.

Hereinafter, certain exemplary embodiments are described in greater detail with reference to the Drawings.

Note that each of the exemplary embodiments described below shows a general or specific example. The numerical values, shapes, materials, structural elements, the arrangement and connection of the structural elements, steps, the processing order of the steps, etc., shown in the following exemplary embodiments are mere examples, and are not intended to limit the present disclosure. Among the structural elements in the following exemplary embodiments, structural elements not recited in any one of the independent claims which indicate the broadest concepts will be described as optional structural elements.

### Embodiment 1

In the present exemplary embodiment, a control method, etc., in which a process for addressing a problem that has occurred in a transaction can be easily performed will be described.

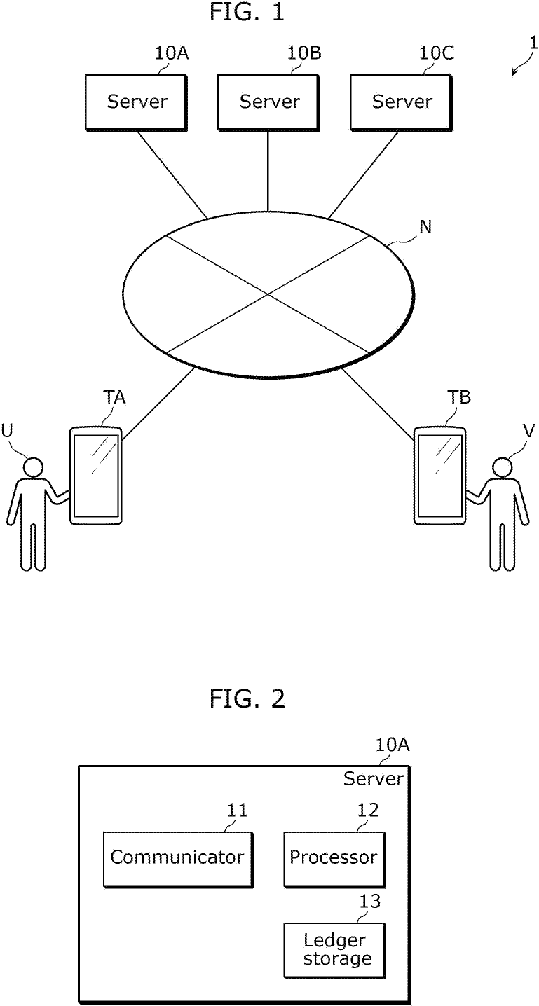

FIG. 1 is an explanatory diagram schematically illustrating the configuration of management system 1 according to the present exemplary embodiment.

As illustrated in FIG. 1, management system 1 includes servers 10A, 10B, 10C (also referred to as servers 10A, etc.). Servers 10A, etc., which are connected to network N, are capable of communicating with each other via network N. Furthermore, terminal TA being used by user U and terminal TB being used by user V are connected to management system 1 via network N.

Management system 1 is a distributed ledger system including a plurality of servers 10A, etc., which are a plurality of devices each holding a distributed ledger. Value information owned by a user is managed on the distributed ledger. Transaction data that is stored into the distributed ledger includes information indicating transfer of the value information.

The value information, which is information indicating a value, is specifically information corresponding to the amount of value. A specific example of the value information is a token, and this case will be described as an example; however, the value information may be information indicating currency (actual currency or cryptocurrency) or may be information that has a value equivalent to currency and can be treated in substantially the same way as currency (specifically, gift certificates or points). Tokens owned by a user are tied to an account of the user and placed under management. Tokens are transferred between users by reducing a predetermined amount of tokens tied to the account of a user who is a source of the transfer and increasing the predetermined amount of tokens tied to the account of a user who is a destination of the transfer. The content of transfer of tokens between users is written into transaction data, and the transaction data is stored into the distributed ledger held by servers 10A, etc.

Server 10A is one of the plurality of servers 10A, etc., that hold the distributed ledger. Transaction data is stored into the distributed ledger held by server 10A. The transaction data that is stored into the distributed ledger is, for example, transaction data indicating the content of transfer of tokens between users, transaction data including information of a contract formed between users, or transaction data including information of actual records. The transaction data will be described in detail later.

Each of servers 10B, 10C, which is a device that has the same functions as the functions of server 10A, operates independently of server 10A.

Note that the present exemplary embodiment describes, as an example, the case where management system 1 includes three servers 10A, etc., but management system 1 may include more servers.

Network N may be any communication line or any network and may include the Internet, a cell-phone carrier network, an access network provided by an Internet provider, and a public access network, for example.

The following describes, as an example, the case where user V purchases a product or a service from user U, in other words, user U provides a product or a service to user V, and user V pays user U value information that is payment for the product or the service. User U is also referred to as a first user, and user V is also referred to as a second user.

For example, user U is a contractor that builds and provides homes, and user V is a person who purchases a home built by user U. In this case, for example, the floor of the home provided by user U is required to be level, but, in actuality, the floor of the home may not be level (or not in the range where the floor can be considered level), which is problematic. User V performs sensing on the floor of the provided home using a sensor and examines whether this problem has occurred. When this problem occurs, user V may intend to request user U to pay value information.

FIG. 2 is a block diagram illustrating the configuration of server 10A according to the present exemplary embodiment.

As illustrated in FIG. 2, server 10A includes communicator 11, processor 12, and ledger storage 13.

Communicator 11 is a communication interface that is connected to network N so as to allow communication therebetween. Communicator 11 includes a communication interface compliant with a communication standard that is appropriate for connection to network N. Communicator 11 may include a communication connector or a communication antenna and a communication circuit that transmit and receive communication signals in compliance with the communication standard.

Processor 12 is a function part that performs processes related to management of a contract formed between users and transfer of value information between users, for example. Processor 12 can be implemented by a processor included in server 10A (such as a central processing unit (CPU), for example) executing a program using memory. Furthermore, processor 12 performs processes related to transaction data.

When processor 12 receives transaction data from terminal TA or TB, processor 12 provides the received transaction data to ledger storage 13, thereby storing the received transaction data into the distributed ledger. The transaction data that processor 12 receives will be described in detail later.

At the time of storing the transaction data into the distributed ledger, processor 12 stores, into the distributed ledger stored in ledger storage 13, said transaction data using a method that depends on the type of the distributed ledger. Furthermore, processor 12 transmits and receives communication data via communicator 11 to and from processor 12 included in another terminal among server 10A, etc., and allows ledger storage 13 included in the other terminal to store said transaction data. For example, when the distributed ledger is a blockchain, processor 12 generates a new block including the transaction data, and after server 10A, etc., reach an agreement about the generated block according to a consensus algorithm, stores said block into the distributed ledger. When only a block about which an agreement has been reached on the basis of the consensus algorithm is stored into the ledger storage in this manner, unnecessary memory usage can be reduced.

Specifically, using communicator 11, processor 12 receives, from terminal TB being used by user V, transfer transaction data (also referred to as first transaction data) indicating that tokens are to be transferred from user U to user V when a problem occurs in a transaction between user U and user V, in other words, in the purchase of a product or a service by user V from user U. Subsequently, processor 12 stores the received transfer transaction data into the distributed ledger. Here, the transfer transaction data is transaction data indicating that a predetermined amount of tokens is to be reduced from the tokens owned by user U and user V is to receive the same amount of tokens as the predetermined amount of tokens reduced. As a result, the tokens that user V owns increases by the same amount as the amount of tokens reduced from the tokens owned by user U. For example, in the transfer of 100 tokens from user U to user V, the tokens that user U owns are reduced by 100 tokens, and the tokens that user V owns are increased by 100 tokens. Reducing or increasing the value information in the foregoing can also be expressed as reducing or increasing values indicated in the value information.

In other words, the transfer transaction data is transaction data indicating that an amount of tokens tied to the account of user U is to be reduced, and the same amount of tokens as the amount of tokens reduced is to be added to the account of user V.

Furthermore, processor 12 may store, into the distributed ledger in advance, contract transaction data (also referred to as second transaction data) to which the digital signatures of user U and user V have been added. The contract transaction data, which is transaction data indicating the content of a contract of purchase of a product or a service by user V from user U (what is called a contract for sale and purchase), includes a condition under which tokens are to be transferred from user U to user V. In this case, when processor 12 receives the transfer transaction data, processor 12 determines whether this condition is satisfied, and when processor 12 determines that this condition is satisfied, processor 12 stores the transfer transaction data into the distributed ledger.

This condition is related to result information related to a product or a service provided by user U, for example, and includes a condition that a condition to be satisfied by the result information when the product or the service provided by user U is appropriate (also referred to as an appropriateness condition) is not satisfied. The result information is specifically a sensor value obtained by performing sensing on the product provided by user U or an object obtained through the service provided by user U.

For example, when user U is a contractor that builds a home, the sensor value is a value that is measured by a sensor sensing the slope (or the gradient) of a floor of the home and indicates the slope of the floor of the home. The appropriateness condition incudes a condition that the slope of the floor of the home provided by user U is less than or equal to 3/1000. Note that “3/1000” means that there is a difference of 3 mm in height between a reference position and a position located 1000 mm away from the reference position. The same applies below.

Furthermore, at the time of making a transaction between user U and user V, processor 12 receives, using communicator 11 from terminal TB being used by user V, transaction data for transferring tokens equivalent to the payment for the product or the service from user V to user U, and stores the received transaction data into the distributed ledger.

Ledger storage 13 is storage in which the distributed ledger is stored. The distributed ledger stored in ledger storage 13 stores one or more items of transaction data and is managed in a tamper-evident manner using the properties of hash values and the like (which will be described later). In ledger storage 13, the transaction data provided from processor 12 is stored into the distributed ledger. In the distributed ledger, transaction data from the past to the present is stored. The transaction data is managed in a tamper-proof manner on the basis of properties in which information recorded on the distributed ledger is difficult to tamper with.

Note that the distributed ledger is, for example, a blockchain; this case will be described as an example, but it is also possible to use a distributed ledger in another form (such as IOTA or hashgraph, for example). The distributed ledger may be a ledger on which, at the time of storing new data, a consensus algorithm (for example, practical Byzantine fault tolerance (PBFT), proof of work (PoW), or proof of stake (PoS)) is executed or may be a ledger on which, at the time of storing new data, the consensus algorithm is not executed.

Hereinafter, processes performed by management system 1 will be described in detail.

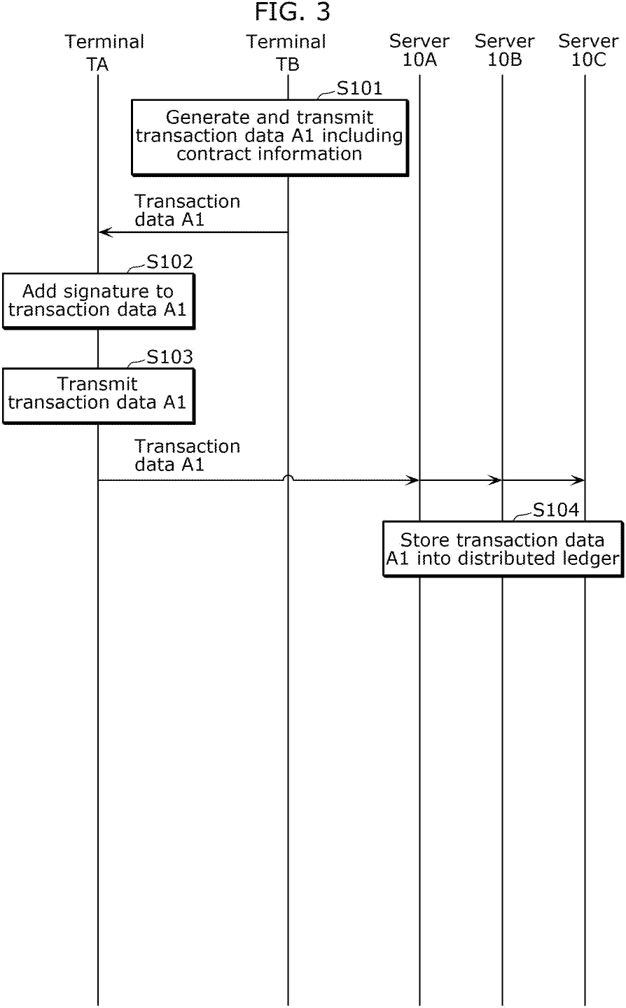

FIG. 3 is the first flowchart illustrating processes performed by management system 1 according to the present exemplary embodiment. The processes illustrated in FIG. 3 are performed by management system 1 at the time when user V is making a contract to purchase a product or a service from user U.

In Step S101, terminal TB generates contract transaction data (also referred to as transaction data A1) including contract information, and transmits the contract transaction data to terminal TA. Terminal TA receives transaction data A1. The contract transaction data includes contract information including an appropriateness condition and an amount of tokens to be transferred when said appropriateness condition is not satisfied (refer to FIG. 8).

In Step S102, terminal TA adds a digital signature (also referred to simply as a signature) to transaction data A1 received in Step S101.

In Step S103, terminal TA transmits, to each of servers 10A, etc., transaction data A1 to which the signature has been added in Step S102. Each of servers 10A, etc., receives transaction data A1.

In Step S104, each of servers 10A, etc., stores, into the distributed ledger, transaction data A1 received in Step S103. At the time of storing transaction data A1 into the distributed ledger, servers 10A, etc., may store said transaction data into the distributed ledger on the condition that an agreement has been reached on the basis of the consensus algorithm. The same applies to the subsequent cases where transaction data is stored into the distributed ledger.

Note that the transaction data for transferring tokens equivalent to the payment for a product or a service may be stored into the distributed ledger before or after transaction data A1 is stored into the distributed ledger or may be included in transaction data A1 and thus stored into the distributed ledger.

Through the series of processes illustrated in FIG. 3, management system 1 can manage the information related to the contract between user U and user V using the distributed ledger.

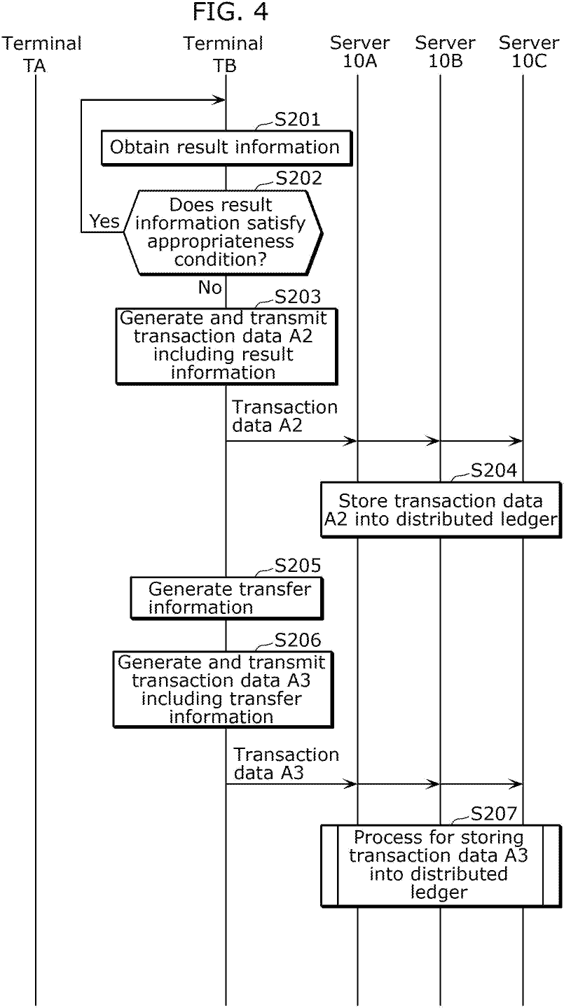

FIG. 4 is the second flowchart illustrating processes performed by management system 1 according to the present exemplary embodiment. The processes illustrated in FIG. 4 are performed by management system 1 after user U provides a product or a service.

In Step S201, terminal TB obtains result information. The result information is, for example, a sensor value obtained by performing sensing on the product provided by user U or an object obtained through the service provided by user U.

In Step S202, terminal TB determines whether the result information obtained in Step S201 satisfies the appropriateness condition. When terminal TB determines that the result information satisfies the appropriateness condition (Yes in Step S202), the processing proceeds to Step S201 and the result information is obtained again, and when terminal TB determines that the result information fails to satisfy the appropriateness condition (No in Step S202), the processing proceeds to Step S203.

In Step S203, terminal TB generates transaction data (also referred to as transaction data A2) including the result information obtained in Step S201 and transmits the transaction data to each of servers 10A, etc. Each of servers 10A, etc., receives transaction data A2.

In Step S204, each of servers 10A, etc., stores, into the distributed ledger, transaction data A2 received in Step S203.

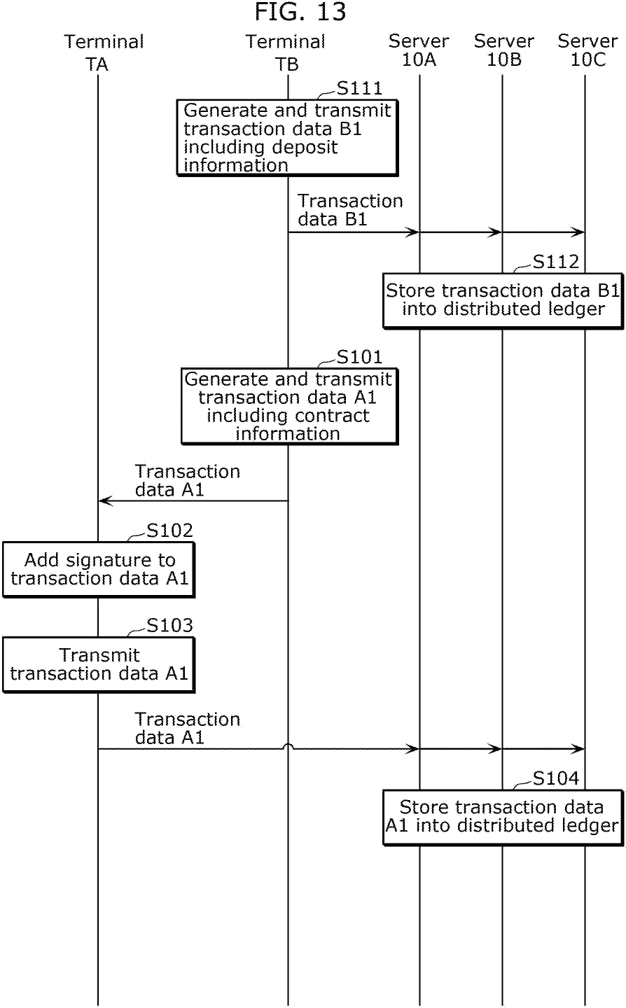

In Step S205, terminal TB generates transfer information. The transfer information includes information indicating, regarding tokens to be transferred between the users, a user who is a source of the transfer, a user who is a destination of the transfer, and the amount of tokens to be transferred (refer to FIG. 11 and FIG. 12). At the time of generating the transfer information, terminal TB refers to the distributed ledger stored in servers 10A, etc., and refers to the contract information included in transaction data A1 stored in the distributed ledger, to generate the transfer information. More specifically, terminal TB generates transfer information indicating that a transfer token amount of tokens that is included in the contract information is to be transferred from user U to user V.

In Step S206, terminal TB generates transaction data (also referred to as transaction data A3) including the transfer information generated in Step S205 and transmits the transaction data to each of servers 10A, etc. Each of servers 10A, etc., receives transaction data A3.

In Step S207, each of servers 10A, etc., performs the process for storing, into the distributed ledger, transaction data A3 received in Step S206. Note that in Step S207, transaction data A3 may or may not be stored into the distributed ledger according to the result of the above process.

Through the series of processes illustrated in FIG. 4, when the result information is not appropriate, management system 1 can transfer tokens from user U to user V according to the transaction data received from terminal TB being used by user V.

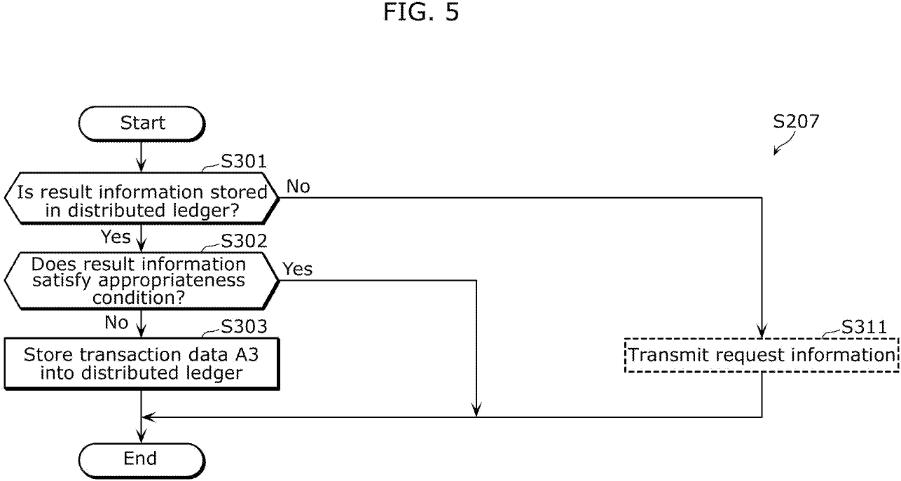

FIG. 5 is the first flowchart illustrating processes performed by servers 10A, etc., according to the present exemplary embodiment. The processes illustrated in FIG. 5 show the first example of the processes included in Step S207 (refer to FIG. 4). The processes illustrated in FIG. 5 are performed on the basis of the fact that transaction data A3 has been received from terminal TB.

In Step S301, processor 12 of each of servers 10A, etc., determines whether the result information is stored in the distributed ledger. When processor 12 determines that the result information is stored in the distributed ledger (Yes in Step S301), the processing proceeds to Step S302, and when processor 12 determines that the result information is not stored in the distributed ledger (No in Step S301), the processing proceeds to Step S311. It is expected that the result information subject to the determination in Step S301 is the result information included in transaction data A2 and stored into the distributed ledger in Step S204 (refer to FIG. 4).

In Step S302, processor 12 of each of servers 10A, etc., determines whether the result information satisfies the appropriateness condition. When processor 12 determines that the result information satisfies the appropriateness condition (Yes in Step S302), processor 12 ends the series of processes illustrated in FIG. 5, and when processor 12 determines that the result information fails to satisfy the appropriateness condition (No in Step S302), the processing proceeds to Step S303. Processor 12 performs this determination by referring to the distributed ledger and obtaining the appropriateness condition stored in the distributed ledger. Note that when the result of the determination in Step S302 is Yes, transaction data A3 may be discarded without being stored into the distributed ledger (in other words, by avoiding being stored into the distributed ledger). By keeping transaction data that fails to satisfy the appropriateness condition from being stored into the distributed ledger, it is possible to reduce the amount of processing in processor 12 for storing the transaction data into the distributed ledger. Furthermore, unnecessary usage of the memory for the distributed ledger can be reduced.

In Step S303, processor 12 stores, into the distributed ledger, transaction data A3 received in Step S206.

In Step S311, processor 12 transmits request information for requesting a third-party organization to perform an investigation of the result information. The third-party organization is, for example, an organization that investigates a reason why the result information has not been stored into the distributed ledger and may be an organization that manages or operates management system 1. The request information may be an electronic mail including a message requesting an investigation of the result information or other information means, for example. Note that Step S311 is not an essential process.

Through the series of processes illustrated in FIG. 5, management system 1 allows terminal TB being used by user V to generate the transaction data for transferring tokens from user U to user V and store the transaction data into the distributed ledger.

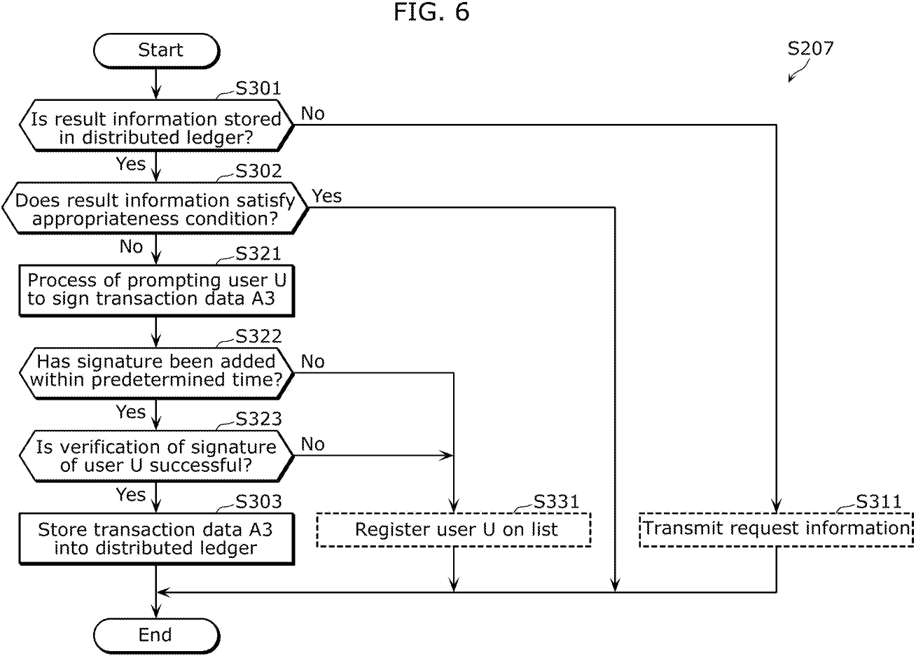

FIG. 6 is the second flowchart illustrating processes performed by servers 10A, etc., according to the present exemplary embodiment. The processes illustrated in FIG. 6 show the second example of the processes included in Step S207 (refer to FIG. 4). Similar to the processes illustrated in FIG. 5, the processes illustrated in FIG. 6 are performed on the basis of the fact that transaction data A3 has been received from terminal TB. The processes illustrated in FIG. 6 include the process of prompting user U to sign transaction data A3, in addition to the processes illustrated in FIG. 5.

Step S301 and Step S302 are the same as those described with reference to FIG. 5.

In Step S321, processor 12 performs the process of prompting user U to sign transaction data A3 received in Step S206.

For example, processor 12 performs the process of transmitting, to terminal TA, a notification for requesting user U to sign transaction data A3. In this case, terminal TA is expected to refer to transaction data A3 in response to this request and transmit, to servers 10A, etc., the signature of user U to be added to transaction data A3. Processor 12 adds the transmitted signature to transaction data A3. It is assumed that the signature of user U is added on the basis of the fact that user U has acknowledged that the result information fails to satisfy the appropriateness condition.

Furthermore, for example, processor 12 may perform the process of transmitting transaction data A3 to terminal TA. In this case, it is expected that terminal TA receives transaction data A3 transmitted thereto, adds the signature of user U to transaction data A3, and transmits transaction data A3 to servers 10A, etc.

In Step S322, processor 12 determines whether, in response to the process executed in Step S321, the signature has been added within a predetermined time from the execution of said process. When processor 12 determines that the signature has been added within the predetermined time (Yes in Step S322), the processing proceeds to Step S323, and when processor 12 determines that the signature has not been added within the predetermined time (No in Step S322), the processing proceeds to Step S331.

In Step S323, processor 12 verifies the signature of user U added in Step S322 and determines whether the verification is successful. When processor 12 determines that the verification is successful (Yes in Step S323), the processing proceeds to Step S303, and when processor 12 determines that the verification is not successful (No in Step S323), the processing proceeds to Step S331.

In Step S303, processor 12 stores, into the distributed ledger, transaction data A3 received in Step S206.

In Step S331, processor 12 registers user U on a list. This list is a list on which users who do not sign within the predetermined time have been registered. This list can be described as a list of providers who have not signed even when requested in a situation where products or services the providers provide are not appropriate. This list is made public and accessible to users who are attempting to purchase the product or the service that user U provides in the future; this list can be used to determine whether to purchase the product or the service. This list can contribute to making people reluctant to purchase products or services that the users on this list provide and end up stopping the purchase. Note that Step S331 is not an essential process.

Note that when the result of the determination in Step S322 or S323 is No, transaction data A3 may be discarded without being stored into the distributed ledger (in other words, by avoiding being stored into the distributed ledger).

Step S311 is the same as that described with reference to FIG. 5.

Through the series of processes illustrated in FIG. 6, management system 1 allows terminal TB being used by user V to generate the transaction data for transferring tokens from user U to user V and store the transaction data into the distributed ledger.

Details of the transaction data will be described below.

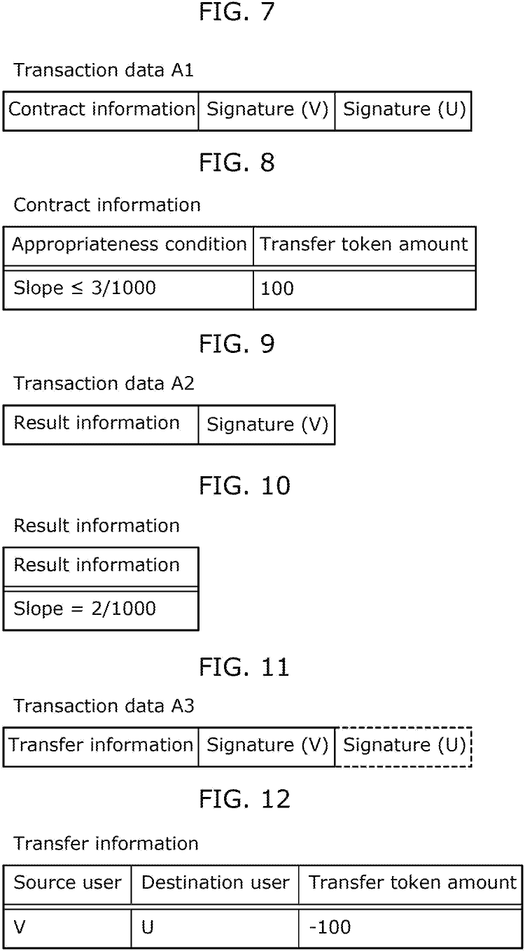

FIG. 7 is an explanatory diagram illustrating transaction data A1 (contract transaction data) which is the first example of the transaction data according to the present exemplary embodiment. FIG. 8 is an explanatory diagram illustrating an example of the contract information according to the present exemplary embodiment.

As illustrated in FIG. 7, transaction data A1 includes the contract information, the signature of user U (indicated as “Signature (U)”; the same applies hereinafter), and the signature of user V (indicated as “Signature (V)”; the same applies hereinafter).

The contract information includes the appropriateness condition and the transfer token amount (refer to FIG. 8).

The appropriateness condition indicates a condition to be satisfied by the product provided by user U or an object obtained through the service provided by user U when the product or the service is appropriate. For example, when user U is a contractor that builds a home, the appropriateness condition includes a condition that the floor of the home provided by user U is level, more specifically, the slope of the floor of the home provided by user U is less than or equal to 3/1000. Note that as the appropriateness condition, a condition related to the size, the weight, the material, or the performance of the product or the object obtained through the service may be used, for example,

The transfer token amount, which indicates the amount of value information to be paid by user U to user V when the product or the service provided by user U is not appropriate, is 100 tokens, for example.

The signature of user U is a digital signature that user U has added to transaction data A1. It is assumed that the signature of user U is added on the basis of the fact that user U has acknowledged the content of transaction data A1, more specifically, the content of the contract information.

The signature of user V is a digital signature that user V has added to transaction data A1. It is assumed that the signature of user V is added on the basis of the fact that user V has acknowledged the content of transaction data A1, more specifically, the content of the contract information.

Note that transaction data A1 may include the transaction data for transferring tokens equivalent to the payment for the product or the service.

FIG. 9 is an explanatory diagram illustrating transaction data A2 which is the second example of the transaction data according to the present exemplary embodiment. FIG. 10 is an explanatory diagram illustrating an example of the result information according to the present exemplary embodiment.

As illustrated in FIG. 9, transaction data A2 includes the result information and the signature of user V.

The result information is a measurement of the product actually provided by user U or an object obtained through the service actually provided by user U. For example, when user U is a contractor that builds a home, the result information includes information indicating that the slope of the floor of the home provided by user U is 2/1000. Note that the result information is information corresponding to an amount to which an outcome condition is applied; in other words, the result information may be information indicating a size, a weight, a material, or performance.

The signature of user V is a digital signature that user V has added to transaction data A2. It is assumed that the signature of user V is added on the basis of the fact that user V has acknowledged the content of transaction data A2, more specifically, the result information.

FIG. 11 is an explanatory diagram illustrating transaction data A3 which is the third example of the transaction data according to the present exemplary embodiment. FIG. 12 is an explanatory diagram illustrating an example of the transfer information according to the present exemplary embodiment.

As illustrated in FIG. 11, transaction data A3 includes the transfer information and the signature of user V. Note that transaction data A3 may further include the signature of user U.

The transfer information is information related to the transfer of the value information that takes place when the product actually provided by user U or an object obtained through the service actually provided by user U fails to satisfy the appropriateness condition. Specifically, the transfer information includes a source user, a destination user, and a transfer token amount (refer to FIG. 12).

Here, it is common that in the transfer information, the source user is a user who uses a terminal that generates transaction data A3. This may be because the source user can reflect their intention to transfer the value information from the source user to the counterpart (that is, the destination user), which can be easily understood. In contrast, transaction data A3 in management system 1 is generated by terminal TB being used by user V who is a destination of tokens to be transferred; thus, this is different from the common case just mentioned.

Therefore, management system 1 has newly introduced a negative value as the transfer token amount. The transfer of the amount of tokens that has a negative value is defined as the opposite transfer of the amount of tokens that has a positive value obtained by inversing the sign of the negative value. Specifically, the transfer of “-100 tokens” from user V to user U means the transfer of “100 tokens” from user U to user V. This allows management system 1 to newly achieve the transfer of tokens from user U to user V using the transaction data generated by user V in accordance with the aforementioned common case.

Specifically, processor 12 sets the items included int the transfer information as follows.

The source user represents a user who is a source of tokens to be transferred, and when the transfer token amount has a negative value, represents a destination of the amount of tokens to be transferred that has a value obtained by inversing the sign of the negative value. The source user is user V when tokens are transferred from user U to user V using the transaction data generated by terminal TB.

The destination user represents a user who is a destination of tokens to be transferred, and when the transfer token amount has a negative value, represents a source of the amount of tokens to be transferred that has a value obtained by inversing the sign of the negative value. The destination user is user U when tokens are transferred from user U to user V using the transaction data generated by terminal TB.

The transfer token amount indicates the amount of tokens to be transferred, and when tokens are transferred from user U to user V using the transaction data generated by terminal TB, is the amount of tokens that has a value obtained by inversing the sign of the amount of tokens, that is, a negative value. The transfer token amount is -100 tokens, for example.

The signature of user V is a digital signature that user V has added to transaction data A3. It is assumed that the signature of user V is added on the basis of the fact that user V has acknowledged the content of transaction data A3, more specifically, the transfer of tokens.

The signature of user U is a digital signature that user U has added to transaction data A3. It is assumed that the signature of user U is added on the basis of the fact that user U has acknowledged the content of transaction data A3, more specifically, the transfer of tokens.

When the result information is not appropriate, management system 1 can transfer tokens from user U to user V according to the transaction data received from terminal TB being used by user V.

Management system 1 according to the present exemplary embodiment can easily perform a process for addressing a problem that has occurred in a transaction.

### Variation of Embodiment 1

The following will describe a control method, etc., according to a variation of the present exemplary embodiment in which a process for addressing a problem that has occurred in a transaction can be easily performed.

In management system 1 according to the present variation, user V transfers a predetermined amount of value information to user U before a contract is made between user U and user V (in other words, transaction data A1 including the contract information is stored into the distributed ledger). The following will describe the processes of transferring tokens from user U to user V when it is later determined that a product or a service provided by user U is not appropriate. This predetermined amount of tokens will also be referred to as a deposit (that is, earnest money).

FIG. 13 is a flowchart illustrating processes performed by management system 1 according to the present variation. The processes illustrated in FIG. 13 are performed by management system 1 at the time when user V is making a contract to purchase a product or a service from user U, and correspond to the processes according to Embodiment 1 illustrated in FIG. 3.

In Step S111, terminal TB generates transaction data (also referred to as transaction data B1) including deposit information indicating that user U transfers a predetermined amount of tokens to user V as a deposit, and transmits the transaction data to each of servers 10A, etc. Each of servers 10A, etc., receives transaction data B1.

In Step S112, each of servers 10A, etc., stores, into the distributed ledger, transaction data B1 received in Step S111.

Steps S101 to S104 are the same as those according to Embodiment 1.

Through the series of processes illustrated in FIG. 13, management system 1 can manage the information related to the contract between user U and user V (including the deposit information) using the distributed ledger.

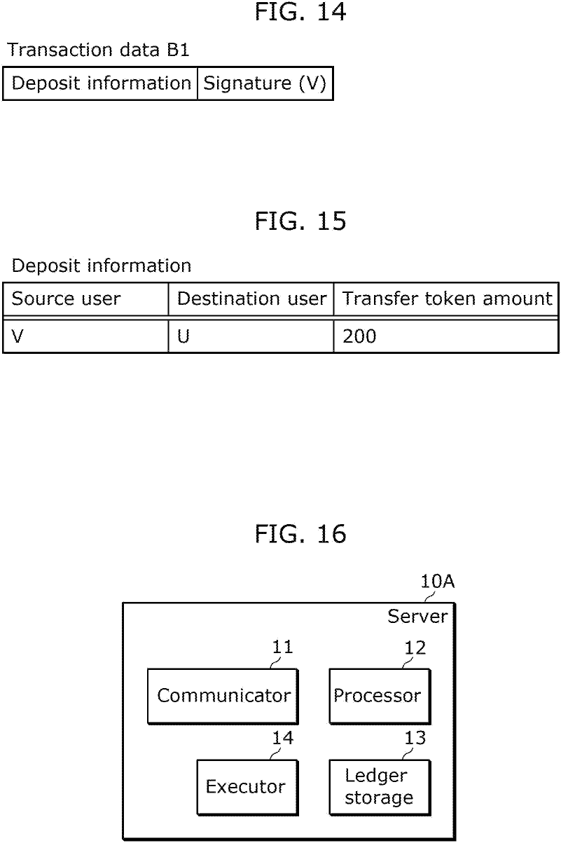

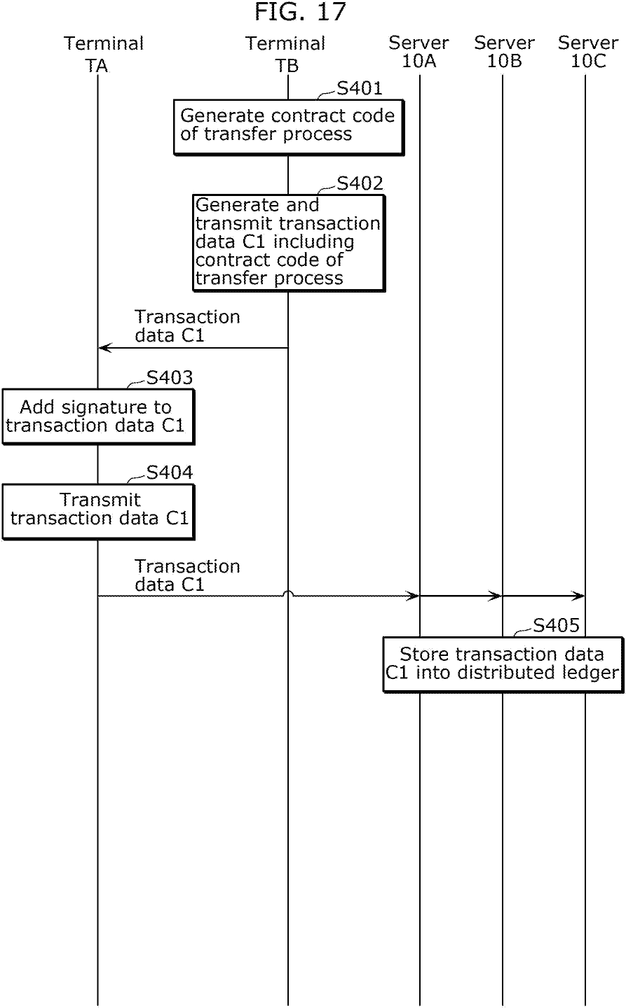

FIG. 14 is an explanatory diagram illustrating transaction data B1 which is an example of the transaction data according to the present variation. FIG. 15 is an explanatory diagram illustrating an example of the deposit information according to the present variation.

As illustrated in FIG. 14, transaction data B1 includes the deposit information and the signature of user V.

The deposit information includes a source user, a destination user, and a transfer token amount (refer to FIG. 15).

The source user represents a user who is a source of tokens to be transferred as a deposit; the source user is user V.

The destination user represents a user who is a destination of the tokens to be transferred as a deposit; the destination user is user U.

The transfer token amount indicates the amount of tokens to be transferred as a deposit; for example, the transfer token amount is 200 tokens.

The signature of user V is a digital signature that user V has added to transaction data B1. It is assumed that the signature of user V is added on the basis of the fact that user V has acknowledged the content of transaction data B1, more specifically, the transfer of tokens.

Note that the application of the tokens transferred from user V to user U as a deposit may be limited to the transfer of tokens that takes place when it is determined that the product or the service is not appropriate. Furthermore, a period during which this limitation is applied may be changed depending on the credibility of user U. The credibility of user U may be, for example, the level of trust for user U providing a relatively high quality product or service. The higher the credibility of the user, the shorter the period during which this limitation is applied may be.

In this manner, tokens are transferred from user V to user U in advance as a deposit; therefore, tokens can be more reliably transferred from user U to user V when the product or the service provided by user U is not appropriate.

### Embodiment 2

In the present exemplary embodiment, another form of a control method, etc., in which a process for addressing a problem that has occurred in a transaction can be easily performed will be described. Specifically, the following will describe an embodiment in which a smart contract is executed to transfer tokens from user U to user V in management system 1 according to the present variation.

FIG. 16 is a block diagram illustrating the configuration of server 10A according to the present exemplary embodiment.

As illustrated in FIG. 16, server 10A according to the present exemplary embodiment includes communicator 11, processor 12, ledger storage 13, and executor 14.

Server 10A according to the present exemplary embodiment is different from server 10A according to Embodiment 1 in that executor 14 is included. Hereinafter, executor 14 will be described.

Executor 14 is a function part that executes a smart contract. Processor 14 can be implemented by a processor included in server 10A (such as a central processing unit (CPU), for example) executing a program using memory.

Specifically, on the basis of the fact that processor 12 stores, into the distributed ledger, transaction data including instruction information that is an instruction to execute a smart contract of a token transfer process (which will be described later), executor 14 reads a contract code of said smart contract from ledger storage 13 and executes the contract code. Executor 14 performs the token transfer process by executing the smart contract.

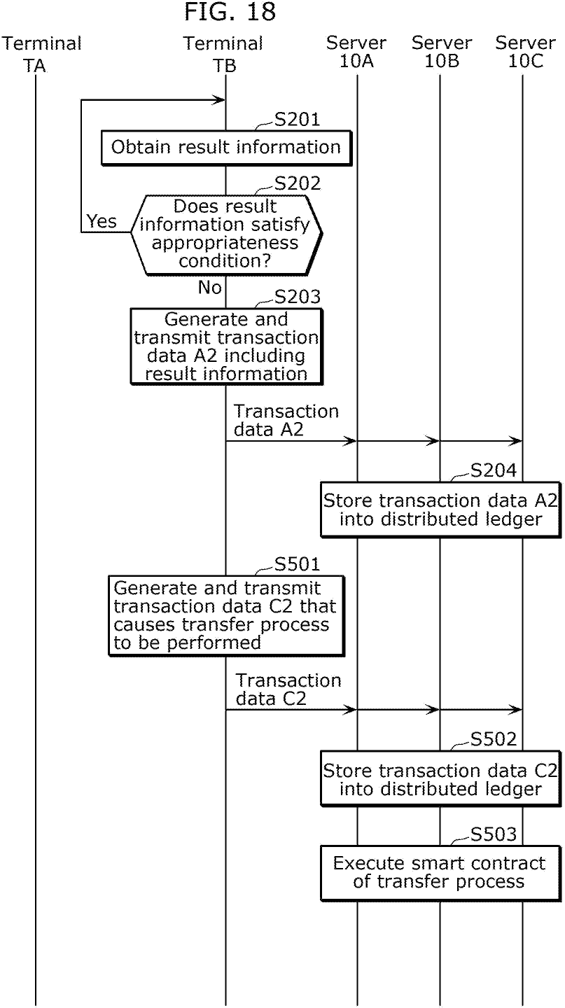

FIG. 17 is the first flowchart illustrating processes performed by management system 1 according to the present exemplary embodiment.

In Step S401, terminal TB generates the contract code of the token transfer process. The token transfer process includes: a determination process of determining whether the result information related to the product or the service provided by user U satisfies the appropriateness condition; and a storage process of storing transaction data A3 into the distributed ledger when it is determined that the result information fails to satisfy the appropriateness condition. The token transfer process corresponds to the process in Step S207 (refer to FIG. 4, FIG. 5, and FIG. 6) according to Embodiment 1. Note that in the token transfer process, before the process of storing transaction data A3 into the distributed ledger (Step S303), the process of generating transaction data A3 is inserted, and transaction data A3 thus generated is stored into the distributed ledger in Step S303.

Note that the token transfer process may include a requesting process of requesting a third-party organization to verify the result information when it is determined in the determination process that the result information fails to satisfy the appropriateness condition. The requesting process is the same as the process in Step S311 according to Embodiment 1.

In Step S402, terminal TB generates transaction data (also referred to as transaction data C1) including the contract code generated in Step S401, and transmits the transaction data to terminal TA. Terminal TA receives transaction data C1. Transaction data C1 may further include information indicating the content of the contract between user U and user V.

In Step S403, terminal TA adds a signature to transaction data C1 received in Step S402.

In Step S404, terminal TA transmits, to each of servers 10A, etc., transaction data C1 to which the signature has been added in Step S403. Each of servers 10A, etc., receives transaction data C1.

In Step S405, each of servers 10A, etc., stores, into the distributed ledger, transaction data C1 received in Step S404.

Through the series of processes illustrated in FIG. 17, management system 1 can manage the information related to the contract between user U and user V (including the contract code of the transfer process) using the distributed ledger.

FIG. 18 is the second flowchart illustrating processes performed by management system 1 according to the present exemplary embodiment.

Steps S201 to S204 illustrated in FIG. 18 are the same as the processes illustrated in FIG. 4.

In Step S501, terminal TB generates transaction data (also referred to as transaction data C2) for performing the transfer process, and transmits the transaction data to each of servers 10A, etc. Each of servers 10A, etc., receives transaction data C2.

In Step S502, each of servers 10A, etc., stores, into the distributed ledger, transaction data C2 received in Step S501.

In Step S503, executor 14 of each of servers 10A, etc., executes the smart contract of the transfer process on the basis of the fact that transaction data C2 has been stored into the distributed ledger in Step S502. Executor 14 of each of servers 10A, etc., executes the smart contract of the transfer process to transfer tokens from user U to user V. When the smart contract is executed, a predetermined program is automatically executed without the intervention of another person or another system. Therefore, the smart contract allows the series of processes to be performed more safely.

Management system 1 according to the present exemplary embodiment can easily perform a process for addressing a problem that has occurred in a transaction. Note that in the above exemplary embodiments, the information received, generated, and transmitted by the management system may be stored into the distributed ledger.

### Additional Comments

The following are additional comments on the distributed ledger according to the exemplary embodiments or the variation. A blockchain will be described herein as an example of the distributed ledger, but the same is true for other distributed ledgers.

FIG. 19 is an explanatory diagram illustrating the data structure of a blockchain.

A blockchain is made up of blocks, each of which is a recording unit of the blockchain, linked together in the form of a chain. Each of the blocks includes a plurality of items of transaction data and a hash value of an immediately preceding block. Specifically, block B2 includes the hash value of previous block B1. Furthermore, a hash value calculated using the hash value of block B1 and the plurality of items of transaction data included in block B2 is included in block B3 as the hash value of block B2. In this manner, blocks are linked together in the form of a chain while including the content of previous blocks; thus, the recorded transaction data is effectively prevented from being tempered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

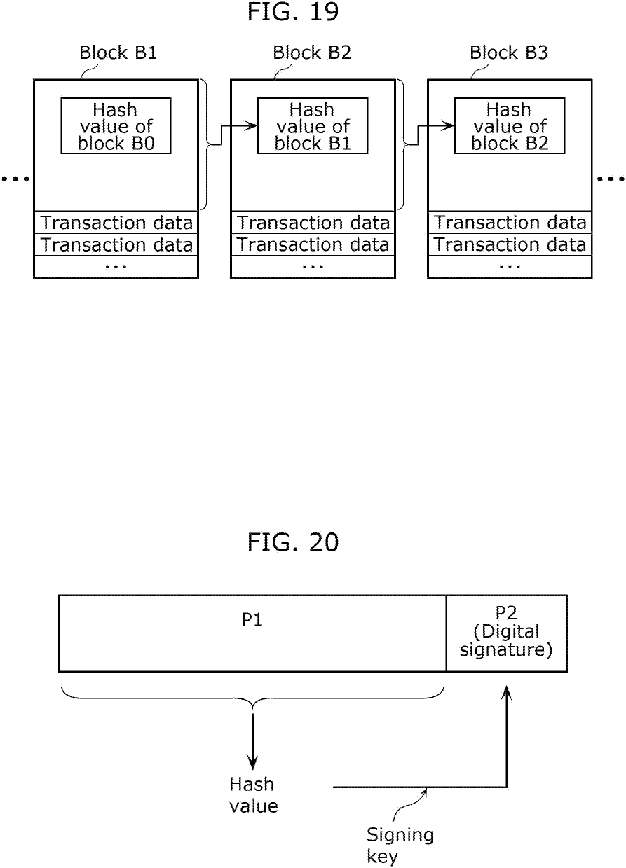

FIG. 20 is an explanatory diagram illustrating the data structure of transaction data.

The transaction data illustrated in FIG. 20 includes transaction body P1 and digital signature P2. Transaction body P1 is a data body included in said transaction data. Digital signature P2 is generated by signing with a signing key of a creator of said transaction data, more specifically, encrypting with a private key of the creator, for the hash value of transaction body P1. The Elliptic Curve Digital Signature Algorithm (ECDSA), CRYSTALS-DILITHIUM, FALCON, SPHINCS+, or the like may be used as a means to provide the digital signature.

Because of including digital signature P2, the transaction data is virtually impossible to tamper with. Thus, the transaction body is protected from tampering.

Note that in the above exemplary embodiments or variation, each of the structural elements may be configured in the form of an exclusive hardware product, or may be realized by executing a software program suitable for the structural element. Each of the structural elements may be realized by means of a program executing unit, such as a CPU or a processor, reading and executing the software program recorded on a recording medium such as a hard disk or semiconductor memory. Here, the software program for realizing the server, etc., according to each of the exemplary embodiments is a program described below.

Specifically, this program causes a computer to execute a control method that is performed by a first device in a distributed ledger system including a plurality of devices each holding a distributed ledger. The first device is included in the plurality of devices. The control method includes: receiving, from a terminal being used by a second user, first transaction data indicating that value information is to be transferred from a first user to the second user; and storing, into the distributed ledger, the first transaction data received.

The server device, etc., according to one or more aspects has been described thus far based on the exemplary embodiments, but the present disclosure is not limited to these exemplary embodiments, Various modifications to the present exemplary embodiments and forms configured by combining structural elements in different exemplary embodiments that can be conceived by those skilled in the art may be included within the scope of one or more aspects as long as these do not depart from the essence of the present disclosure.

### INDUSTRIAL APPLICABILITY

The present disclosure can be used in management systems that manage value information owned by users.

1. A control method that is performed by a first device included in a plurality of devices, the control method comprising:
receiving, from a terminal being used by a second user, first transaction data indicating that value information is to be transferred from a first user to the second user; and
storing, into a distributed ledger, the first transaction data received.

2. The control method according to claim 1, wherein
the first transaction data is transaction data indicating that value information owned by the first user is to be reduced and the second user is to receive a same amount of value information as an amount of the value information reduced.

3. The control method according to claim 1, further comprising:
storing, into the distributed ledger in advance, second transaction data to which a digital signature of the first user and a digital signature of the second user have been added, the second transaction data indicating a condition under which the value information is to be transferred from the first user to the second user;
when the first transaction data is received, determining whether the condition indicated in the second transaction data is satisfied; and
when the first transaction data is received and it is determined that the condition is satisfied, storing, into the distributed ledger, the first transaction data received.

4. The control method according to claim 3, further comprising:
receiving, from the terminal being used by the second user, third transaction data including result information related to a product or a service provided by the first user; and
storing, into the distributed ledger, the third transaction data received, wherein
the condition indicated in the second transaction data includes a condition that an appropriateness condition to be satisfied by the result information when the product or the service provided by the first user is appropriate is not satisfied.

5. The control method according to claim 4, wherein
the result information is a sensor value obtained by performing sensing on the product provided by the first user or an object obtained through the service provided by the first user.

6. The control method according to claim 3, further comprising:
determining whether third transaction data including result information related to a product or a service provided by the first user has been received from the terminal being used by the second user; and
when it is determined that the third transaction data has not been received, transmitting request information for requesting a third-party organization to verify the result information.

7. The control method according to claim 1, further comprising:
performing a process of adding a digital signature of the first user to the first transaction data received;
after performing the process, verifying the digital signature of the first user added to the first transaction data; and
when the digital signature of the first user is successfully verified, storing, into the distributed ledger, the first transaction data received.

8. The control method according to claim 7, wherein
when the digital signature of the first user is not added to the first transaction data within a predetermined time after the process is performed, the first transaction data received is kept from being stored into the distributed ledger.

9. The control method according to claim 7, wherein
when the digital signature of the first user is not added to the first transaction data within a predetermined time after the process is performed, the first user is registered on a predetermined list.

10. The control method according to claim 1, wherein
fourth transaction data is stored in the distributed ledger, the fourth transaction data including a contract code of a smart contract for performing a transfer process in which the value information is transferred from the first user to the second user,
the first transaction data includes a command for executing the smart contract, and
the value information is transferred from the first user to the second user by storing, into the distributed ledger, the first transaction data received and executing the smart contract.

11. The control method according to claim 10, wherein
the transfer process includes:
a determination process of determining whether result information related to a product or a service provided by the first user satisfies an appropriateness condition that is to be satisfied by the result information when the product or the service provided by the first user is appropriate; and
a storage process of storing, into the distributed ledger, the first transaction data received, when it is determined in the determination process that the result information fails to satisfy the appropriateness condition.

12. The control method according to claim 11, wherein
the transfer process includes a requesting process of requesting a third-party organization to verify the result information when it is determined in the determination process that the result information fails to satisfy the appropriateness condition.

13. A control device that is a first device included in a plurality of devices, the control device comprising:
a processor; and
memory connected to the processor, wherein
using the memory, the processor:
receives, from a terminal being used by a second user, first transaction data indicating that value information is to be transferred from a first user to the second user; and
stores, into a distributed ledger, the first transaction data received.

14. A non-transitory computer-readable recording medium having recorded thereon a program for causing a computer to execute the control method according to claim 1.
